(19) United States
(12) Patent Application Publication
(10) Pub. No.: US 2006/0220579 A1
(43) Pub. Date: Oct. 5, 2006

(54) Method and apparatus for driving electron emission panel

(75) Inventor: Chul-Ho Lee, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/375,007

(22) Filed: Mar. 15, 2006

(30) Foreign Application Priority Data
Mar. 29, 2005 (KR) 10-2005-0025989

(51) Int. Cl. G09G 3/10

(52) U.S. Cl. 315/169.3; 315/169.1

(57) ABSTRACT

An electron emission panel driving method and apparatus that is capable of reducing the panel's power consumption. The driving method includes the operation of comparing two successive frames of image data. When the two successive frames are not identical, each of the two frames is driven during a one-frame period, and when the two successive frames are identical, only one frame is driven during a two-frame period.

### CROSS-REFERENCE TO RELATED PATENT APPLICATIONS

This application claims priority to and the benefit of Korean Patent Application No. 10-2005-0025989, filed on Mar. 29, 2005, which is hereby incorporated by reference for all purposes as if fully set forth herein.

### BACKGROUND OF THE INVENTION

1. Field of the Invention

The present invention relates to a method and apparatus for driving an electron emission panel including an electron emission device, and more particularly, to a method and apparatus that may reduce power consumption when driving an electron emission panel.

2. Description of the Related Art

Generally, electron emission devices include those using a hot cathode or a cold cathode as an electron source.

Electron emission devices using the cold cathode include field emitter arrays (FEA), surface conduction emitters (SCE), metal-insulator-metal (MIM), metal-insulator-semiconductor (MIS), and ballistic electron surface emitting (BSE) devices.

In the FEA devices, electrons may be emitted easily by a difference of electric fields under a vacuum when a material having a low work function or a high β function, and a tip structure made of Mo or Si, a carbon-based material such as graphite or diamond like carbon (DLC), and a nano-material such as nano tube or nano wire is used as an electron emission unit.

The SCE device includes a conductive thin film between a first electrode and a second electrode facing each other on a first substrate, and fine cracks on the conductive thin film for the electron emission unit. Applying a voltage to the electrodes causes a current to flow on a surface of the conductive thin film, thereby emitting electrons from the electron emission unit (i.e. the fine cracks).

In the MIM and MIS devices, electron emission units may be formed of MIM and MIS, and applying a voltage between the metals, or metal and semiconductor, emits electrons from the metal or semiconductor having higher electron electric potential to the metal having lower electron electric potential.

In the BSE device, a metal or semiconductor electron supplying layer is formed on an ohmic electrode, and an insulating layer and a metal thin film are formed on the electron supplying layer. Here, electrons may be transported without being dispersed when a semiconductor's size decreases to a level smaller than that which allows mean free flow of the electrons in the semiconductor, and electrons are emitted when a voltage is applied to the ohmic electrode and the metal thin film.

In an electron emission panel, pixels are defined at regions where scan electrodes and data electrodes overlap, input gradation displayed on each pixel is generated from an input image signal, and the panel is driven in pixel units according to the input gradation. Here, scan pulses are sequentially applied to the scan electrodes, and data pulses are applied to the data electrodes according to the input gradation to display an image corresponding to the image signals on the panel.

The data pulses may be applied to the data electrodes using a pulse width modulation (PWM) method or a pulse amplitude modulation (PAM) method. When applying scan pulses and data pulses to drive the electron emission panel, switching operations corresponding to the quantity of scan and data pulses are generated. Such switching operations increase the panel's power consumption, and noise may be generated according to the switching frequency.

### SUMMARY OF THE INVENTION

The present invention provides an electron emission panel driving method and apparatus that may be capable of reducing the panel's power consumption by driving one frame during a two-frame period when neighboring frames are identical.

Additional features of the invention will be set forth in the description which follows, and in part will be apparent from the description, or may be learned by practice of the invention.

The present invention discloses a method of driving an electron emission panel including pixels defined at regions where scan electrodes and data electrodes cross each other, where input gradation data displayed on each pixel is formed using input image signals and the pixels are driven according to the input gradation data. The method includes comparing two successive frames, driving each of the two frames during a one-frame period when the two frames are not identical, and driving only one frame of the two frames during a two-frame period when the two successive frames are identical.

The present invention also discloses an apparatus for driving an electron emission panel including pixels at regions where scan electrodes and data electrodes cross each other. The apparatus includes an image processor to generate image data, a frame comparing unit to compare two successive frames of the image data, and a logic controller to generate a scan signal and a data signal based on the comparison result of the frame comparing unit. A scan driving unit drives the scan electrodes according to the scan signal, and a data driving unit drives the data electrodes according to the data signal. The logic controller generates the scan signal and the data signal to drive each of the two successive frames during a one-frame period when the two successive frames are not identical, and it generates the scan signal and the data signal to drive only one frame of the two successive frames during a two-frame period when the two successive frames are identical.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principle of the invention.

FIG. 1 is a perspective view of an electron emission panel that may be driven by a method and apparatus for driving an electron emission panel according to an embodiment of the present invention.

FIG. 2 is a perspective view of an electron emission panel according to an embodiment of the present invention.

FIG. 3 is a schematic diagram of an electrode arrangement to which driving signals may be applied in the electron emission panel of FIG. 1 and FIG. 2.

FIG. 4 is a flow chart of a method of driving the electron emission panel according to an embodiment of the present invention.

FIG. 5 is a schematic view of image signal data in frames including 4×4 pixels when two adjacent frames display different images.

FIG. 6 is a schematic view of image signal data in frames including 4×4 pixels when two adjacent frames display the same image.

FIG. 7 is a schematic timing diagram of PWM driving waveforms with respect to the image signal data of FIG. 5.

FIG. 8 is a schematic timing diagram of PWM driving waveforms with respect to the image signal data of FIG. 6 according to a conventional electron emission panel driving method.

FIG. 9 is a schematic timing diagram of PWM driving waveforms with respect to the image signal data of FIG. 6 according to a progressive driving method of the present invention.

FIG. 10 is a schematic timing diagram of PWM driving waveforms with respect to the image signal data of FIG. 6 according to an interlaced driving method of the present invention.

FIG. 11 is a schematic timing diagram of PAM driving waveforms of the image signal data of FIG. 5 according to an embodiment of the present invention.

FIG. 12 is a schematic timing diagram of PAM driving waveforms of the image signal data of FIG. 6 according to a conventional electron emission panel driving method.

FIG. 13 is a schematic timing diagram of PAM driving waveforms of the image signal data of FIG. 6 according to the progressive driving method of the present invention.

FIG. 14 is a schematic timing diagram of PAM driving waveforms of the image signal data of FIG. 6 according to the interlaced driving method of the present invention.

FIG. 15 is a schematic block diagram of an electron emission apparatus for driving an electron emission panel according to an embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

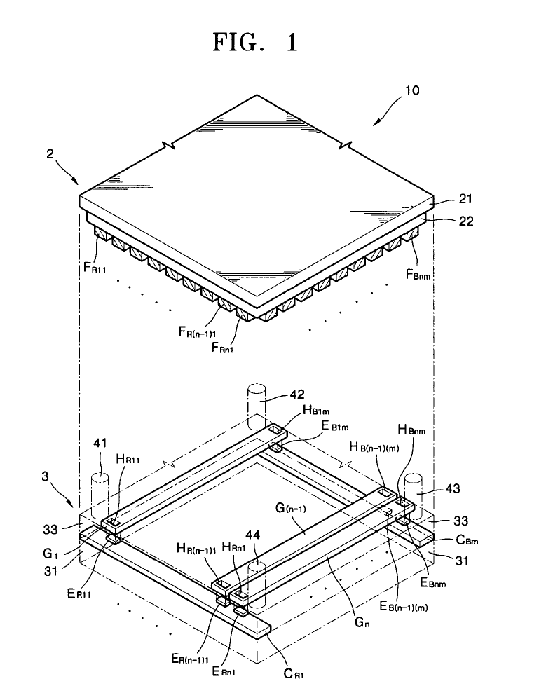

FIG. 1 is a perspective view of an electron emission panel that may be driven by a method and apparatus according to an embodiment of the present invention.

Referring to FIG. 1, the electron emission panel 10 includes a first panel 2 and a second panel 3 separated from each other, and space bars 41, 42, 43, and 44.

The first panel 2 includes a transparent first substrate 21, an anode 22, and phosphor cells F_{R11}, . . . , F_{Bnm}.

The anode 22 is arranged on a surface of the first substrate 21 facing a second substrate 31, and the phosphor cells F_{R11}, . . . , F_{Bnm} are arranged on a surface of the anode 22 facing the second substrate 31. Red, green, and blue phosphor materials are arranged on the phosphor cells F_{R11}, . . . , F_{Bnm}, respectively.

The second panel 3 includes the second substrate 31, electron emission sources E_{R11}, . . . , E_{Bnm}, an insulating layer 33, and cathodes C_{R1}, . . . , C_{Bm} overlapping gate electrodes G₁, . . . , Gₙ.

The cathodes C_{R1}, . . . , C_{Bm} are electrically connected with the electron emission sources E_{R11}, . . . , E_{Bnm}, and the insulating layer 33 and the gate electrodes G₁, . . . , Gₙ include penetration holes H_{R11}, . . . , H_{Bnm} corresponding to the electron emission sources E_{R11}, . . . , E_{Bnm}.

Driving voltages are applied to the cathodes and gate electrodes (a voltage applied to the cathode is generally lower than that applied to the gate electrode). When an electric potential difference between them exceeds an electron emission starting voltage, the electron emission sources start to emit electrons. Here, when applying a high positive voltage of about 1-4 KV to the anode 22, electrons emitted from the electron emission sources accelerate and converge toward the phosphor cells, thereby generating visible light when the electrons collide with the phosphor material in the phosphor cells.

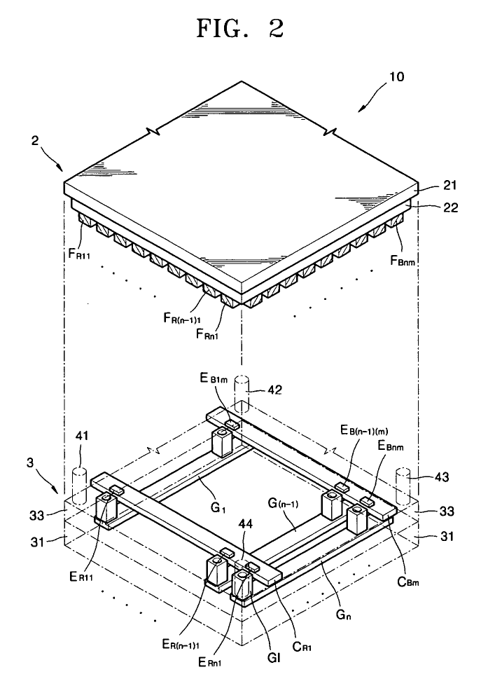

FIG. 2 is a perspective view of another example of an electron emission panel that may be driven according to an embodiment of the present invention.

Referring to FIG. 2, the cathodes and gate electrodes are arranged differently from those of the electron emission panel of FIG. 1. Otherwise, the electron emission panel of FIG. 2 has a similar structure to that of FIG. 1, and it is governed by the same operational principles as that of the panel of FIG. 1.

Referring to FIG. 2, an electron emission panel 10 includes a first panel 2 and a second panel 3 separated from each other, and space bars 41, 42, 43, and 44.

The first panel 2 includes a transparent first substrate 21, an anode 22, and phosphor cells F_{R11}, . . . , F_{Bnm}.

The anode 22 is arranged on a surface of the first substrate 21 facing a second substrate 31, and the phosphor cells F_{R11}, . . . , F_{Bnm} are arranged on a surface of the anode 22 facing the second substrate 31. Red, green, and blue phosphor materials are arranged on the phosphor cells F_{R11}, . . . , F_{Bnm}, respectively.

The second panel 3 includes the second substrate 31, electron emission sources E_{R11}, . . . , E_{Bnm}, an insulating layer 33, and cathodes C_{R1}, . . . , C_{Bm} overlapping gate electrodes G₁, . . . , Gₙ.

The cathodes C_{R1}, . . . , C_{Bm} are electrically connected with the electron emission sources E_{R11}, . . . , E_{Bnm}, and the insulating layer 33 and the gate electrodes G₁, . . . , Gₙ include penetration holes corresponding to the electron emission sources E_{R11}, . . . , E_{Bnm}.

Counter electrodes GI are formed on a surface of the gate electrodes G₁ , . . . , Gₙ facing the first substrate, and they are located on sides of the electron emission sources E_{R11}, . . . , E_{Bnm} while penetrating the insulating layer 33.

In the electron emission panel of FIG. 2, in which the gate electrodes G₁, . . . , Gₙ are located under the cathodes C_{R1}, . . . , C_{Bm}, an electric potential difference between the counter electrodes and the cathodes causes the cathodes to emit electrons, which are slightly attracted to the counter electrodes GI and then accelerated toward the anode 22 of the first panel 2.

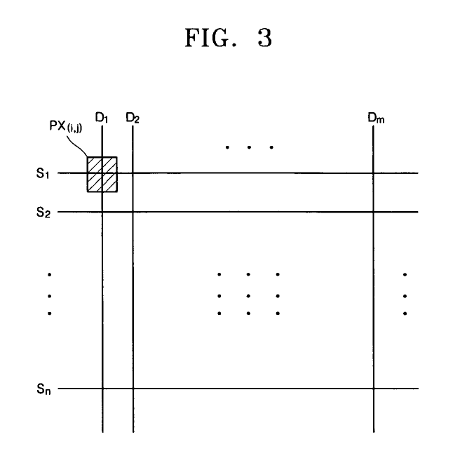

FIG. 3 is a schematic diagram of an electrode arrangement, to which driving signals may be applied, in the electron emission panels of FIG. 1 and FIG. 2.

Referring to FIG. 3, scan electrodes S₁, . . . , Sₙ extend in a predetermined direction, and data electrodes D₁, . . . , Dₘ, which extend orthogonally to the scan electrodes, overlap the scan electrodes. Pixels (Px), which are basic units for displaying images, are defined at regions where the scan and data electrodes overlap. Scan driving signals are sequentially applied to the scan electrodes, and corresponding data driving signals are applied to the data electrodes. Thus, visible bright lights corresponding to the pixels may be emitted.

Although regions where the scan electrodes and the data electrodes cross each other are defined as pixels Px(i,j) in FIG. 3, when the phosphor material emitting red, green, and blue light is utilized, visible light is emitted from regions where three data electrodes and one scan electrode cross each other. Hence, pixels are defined by a region where three data electrodes and one scan electrode cross each other. Further, regions where one data electrode and one scan electrode cross each other are sub-pixels.

The scan electrodes of FIG. 3 may correspond to the cathodes or the gate electrodes of FIG. 1 and FIG. 2, and the data electrodes of FIG. 3 may correspond to the gate electrodes or the cathodes of FIG. 1 and FIG. 2.

FIG. 4 is a flow chart schematically illustrating a method of driving an electron emission panel according to an embodiment of the present invention.

Image signals are input to the electron emission panel and converted into input gradations that are displayed by pixels in a frame unit, that is, a displaying period. The electron emission panel includes pixels defined in regions where the scan electrodes and the data electrodes cross, and the panel is driven according to the input gradations. Referring to FIG. 4, the driving method 400 includes operations of comparing frames (S401), basically driving the panel (S402), and expansively driving the panel (S403).

In the frame-comparing operation (S401), two successive frames are compared to each other. In the operation of basically driving the panel (S402), which occurs when the two successive frames are not identical, each of the two frames is driven during one frame driving period. In the expansion driving operation (S403), which occurs when the two successive frames are identical, one of the two frames is driven during a two-frame period.

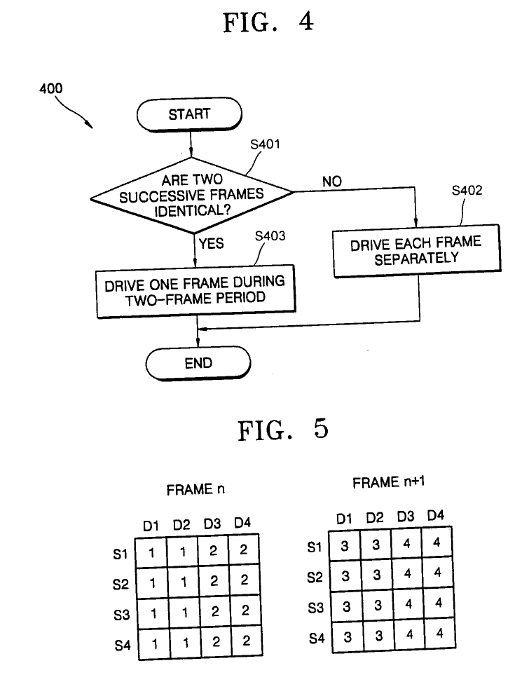

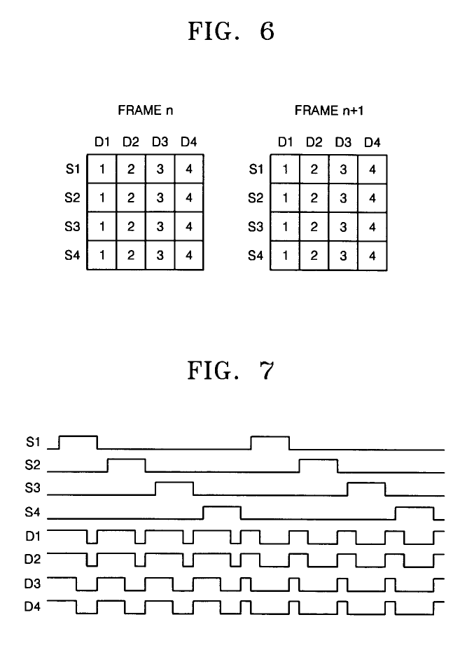

The two frames may be compared to each other in S401 by comparing the input gradation data corresponding to the pixels in the frames. FIG. 5 and FIG. 6 illustrate the image signal data in frames of 4×4 pixels, and the image signal data are represented as input gradations displayed by the pixels.

Referring to FIG. 5 and FIG. 6, S1 through S4 are sequentially arranged scan electrode lines that extend from a first side of the electron emission panel to a second side of the panel, and D1 through D4 are sequentially arranged data electrode lines that extend from a third side of the panel to a fourth side of the panel. Coordinates of FIG. 5 and FIG. 6 represent pixels located on the electron emission panel at regions where the scan electrode lines and the data electrode lines overlap, and in the present embodiment, values of the coordinates represent gradation weights corresponding to the pixels.

In FIG. 5, D1 and D2 lines of an nth frame have gradation weights of 1, and D1 and D2 lines of an n+1th frame have gradation weights of 3. Additionally, D3 and D4 lines of the nth frame have gradation weights of 2, and D1 and D2 lines of n+1th frame have gradation weights of 4. Therefore, the image data of the nth frame and the n+1th frame are not identical.

In FIG. 6, D1 lines of an nth frame and an n+1th frame have gradation weights of 1, D2 lines of the nth frame and the n+1th frame have gradation weights of 2, D3 lines of the nth frame and the n+1th frame have gradation weights of 3, and D4 lines of the nth frame and the n+1th frame have gradation weights of 4. Accordingly, the image data of the nth frame and the n+1th frame are identical.

The basic driving operation (S402) is performed when two successive frames are not identical. In this case, the image signal data of the two successive frames are not identical, as illustrated in FIG. 5, and the panel may be driven by scan pulses applied to the scan electrode lines S1 through S4 and data pulses applied to the data electrode lines D1 through D4 having the waveforms illustrated in FIG. 7 or FIG. 11.

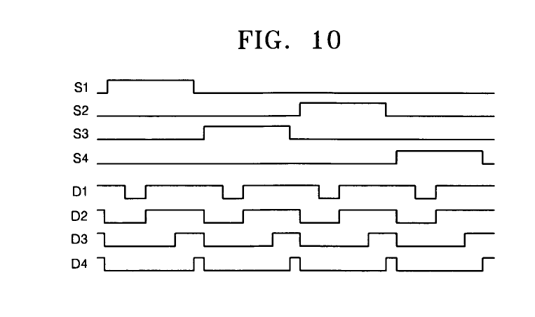

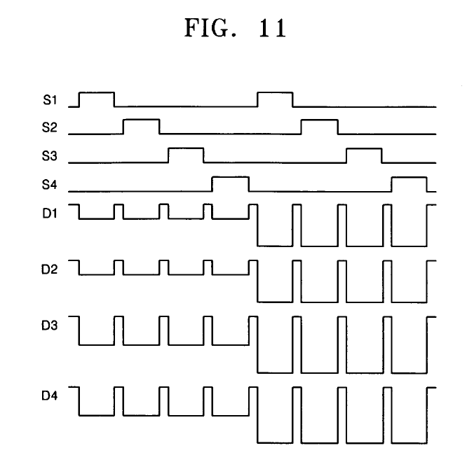

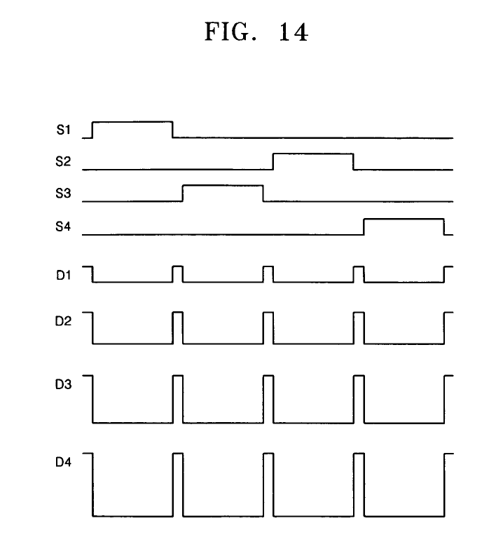

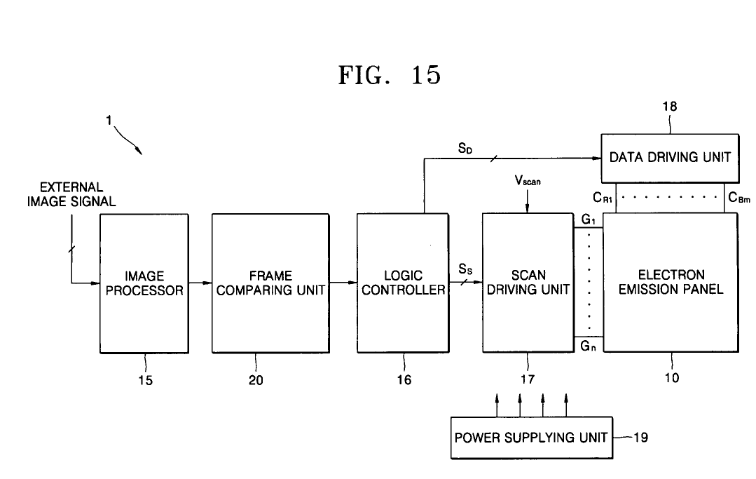

Furthermore, the expansion driving operation (S403) is performed when the two successive frames are identical. In this case, the image signal data of the two successive frames are identical, and the panel may be driven by the scan pulses applied to the scan electrode lines S1 through S4 and the data pulses applied to the data electrode lines D1 through D4 having the waveforms illustrated in FIG. 9 or FIG. 10, or FIG. 13 or FIG. 14.

In the basic driving operation (S402) and the expansion driving operation (S403), the panel may be driven using a pulse width modulation (PWM) driving method according to the input gradations.

Alternatively, the panel may be driven using a pulse amplitude modulation (PAM) driving method according to the input gradations.

Additionally, in the basic driving operation (S402) and the expansion driving operation (S403), the scan pulses may be sequentially applied to the scan electrodes and the data pulses, which correspond to the scan pulses, are applied to the data electrodes to drive the panel as illustrated in FIG. 7, FIG. 9, FIG. 10, FIG. 11, FIG. 13 and FIG. 14.

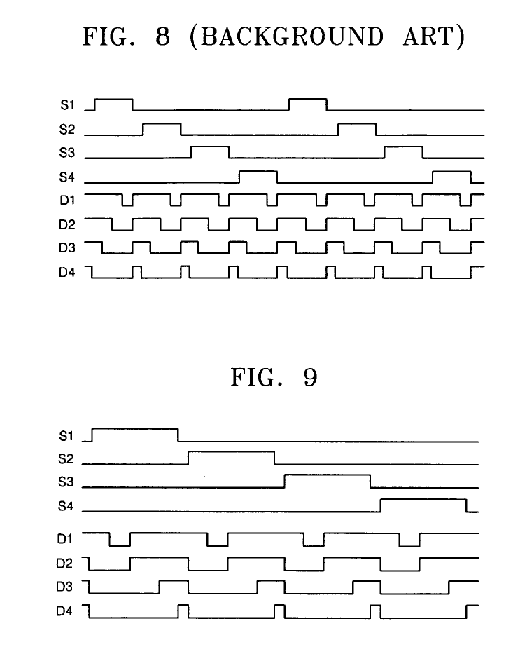

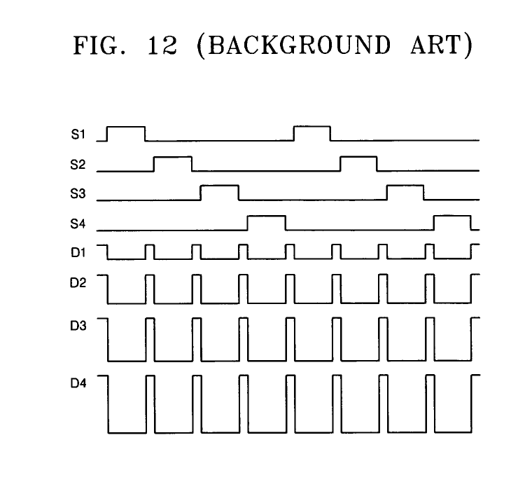

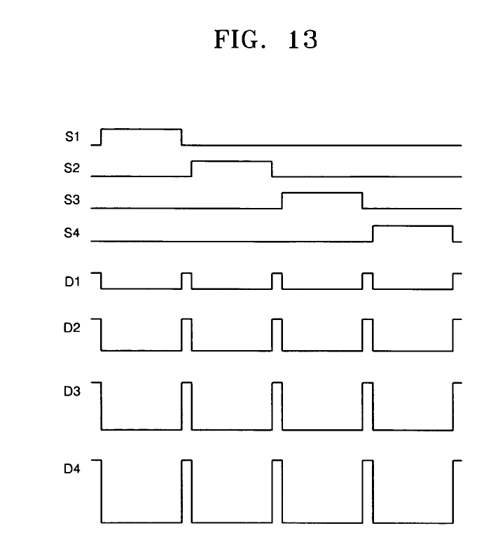

In the above driving methods, the scan pulses may be applied using a progressive scan driving method in which scan pulses are progressively applied to sequentially arranged scan electrodes (e.g., FIG. 7, FIG. 9). Alternatively, the scan pulses may be applied using an interlacing driving method in which odd numbered scan lines are sequentially scanned and then even numbered scan lines are sequentially scanned or vice versa (e.g., FIG. 10). FIG. 7, FIG. 8, FIG. 9 and FIG. 10 are timing diagrams of PWM driving waveforms, and FIG. 11, FIG. 12, FIG. 13 and FIG. 14 are timing diagrams of PAM driving waveforms.

FIG. 7 is a schematic timing diagram of the PWM driving waveforms with respect to the image signal data of FIG. 5. FIG. 8 is a timing diagram of conventional PWM driving waveforms with respect to the image signal data of FIG. 6. FIG. 9 is a timing diagram of PWM driving waveforms with respect to the image signal data of FIG. 6 using the progressive driving method according to an embodiment of the present invention, and FIG. 10 is a timing diagram of PWM driving waveforms with respect to the image signal data of FIG. 6 using the interlacing driving method according to an embodiment of the present invention.

Referring to the drawings, scan pulses are sequentially applied to the scan electrode lines S1 through S4 as the driving signals corresponding to the two successive frames, that is, the nth frame and the n+1th frame of FIG. 5 and FIG. 6, and blanking sections exist between the scan pulses.

Additionally, data pulses, which have pulse widths according to the gradation weights, are applied so as to correspond to the scan pulses. The above processes are performed with respect to the two successive frames corresponding to the nth frame and the n+1 th frame of FIG. 5 and FIG. 6. Therefore, switching operations corresponding to the numbers of scan pulses and data pulses occur at each frame.

In FIG. 9 and FIG. 10, two successive frames (i.e. the nth frame and the n+1th frame) are driven by the image signal data corresponding to one frame period. In such a case, the width of scan pulses and data pulses of FIG. 9 and FIG. 10 is twice that of scan pulses and data pulses of FIG. 8.

Therefore, the number of switching operations may be half the number of switching operations when utilizing the conventional driving method illustrated in FIG. 8. According to embodiments of the present invention, when two successive frames are identical, the switching frequency may be half that used in the conventional art. Hence, according to Equation 1 shown below, power consumption for the switching operation may be half the conventional power consumption. In Equation 1, P represents switching power consumption for charging/discharging, C is a capacitance of a capacitor formed by the panel, and f represents the switching frequency.
P=C×V²×f (1)

Furthermore, since the switching frequency may be half that used in the conventional art, noise generated by the switching frequency may be reduced.

FIG. 10 illustrates the PWM driving waveforms using the interlacing driving method. Even when a 60 Hz image signal is driven by a frequency of 30 Hz, defects such as flicker may be reduced.

Additionally, when the two successive frames are identical, the blanking sections may be reduced as illustrated in FIG. 9, FIG. 10, FIG. 13 and FIG. 14, and thus, power consumption and noise may be reduced.

FIG. 11 is a timing diagram of the PAM driving waveforms with respect to the image signal data of FIG. 5. FIG. 12 is a schematic timing diagram of conventional PAM driving waveforms with respect to the image signal data in FIG. 6. FIG. 13 is a schematic timing diagram of PAM driving waveforms with respect to the image signal data in FIG. 6 using the progressive driving method according to an embodiment of the present invention. FIG. 14 is a schematic timing diagram of the PAM driving waveforms with respect to the image signal data in FIG. 6 using the interlacing driving method according to an embodiment of the present invention.

FIGS. 11 through 14, which correspond to FIGS. 7 through 10 in the PWM driving method, illustrate scan signals and data signals that may be respectively applied to the scan electrode lines and the data electrode lines in the PAM driving method according to embodiments of the present invention.

FIG. 15 is a block diagram of an electron emission apparatus for driving an electron emission panel according to an embodiment of the present invention.

Referring to FIG. 15, the electron emission apparatus 1 includes an electron emission panel 10 and a driving device. The driving device includes an image processor 15, a logic controller 16, a scan driving unit 17, a data driving unit 18, and a power supplying unit 19.

The image processor 15 receives an image signal and generates internal image signals such as red (R), green (G), and blue (B) image data, a clock signal, and a vertical and a horizontal synchronization signal.

The logic controller 16 generates driving signals including a data driving signal S_{D} and a scan driving signal S_{S} according to the image signals received from the image processor 15. The data driving unit 18 processes the data driving signal S_{D} to generate a display data signal and applies the generated display data signal to the data electrode lines C_{R1}, . . . , C_{Bm} of the electron emission panel 10. The data driving signal S_{D} includes the R, G, and B image data.

The scan driving unit 17 processes the scan driving signal S_{S} and applies the processed signal to the scan electrode lines G₁, . . . , Gₙ. When the scan driving unit 17 receives a start pulse, it shifts by one line unit whenever the horizontal synchronization signal is applied to sequentially apply the scan signals to the scan electrode lines.

The power supplying unit 19 applies a voltage to the image processor 15, the logic controller 16, the scan driving unit 17, the data driving unit 18, and anodes of the electron emission panel 10. The power supplying unit 19 includes an anode voltage supplying unit to gradually increase voltage of an anode electrode.

Additionally, the electron emission apparatus 1 of the present invention includes a frame comparing unit 20. The frame comparing unit 20 compares two successive frames of image signal data to determine whether the two frames are identical. Accordingly, the logic controller 16 performs the expansion driving operation (S403, refer to FIG. 4) when the two frames are identical and the basic driving operation (S402, refer to FIG. 4) when the two frames are not identical.

According to a method and apparatus for driving an electron emission panel of the present invention, when successive frames are identical, only one frame is driven during a two-frame period to reduce the panel's power consumption.

Furthermore, since switching frequency may be reduced, noise generated by the switching operations may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of driving an electron emission panel including pixels defined at regions where scan electrodes and data electrodes cross each other, where input gradation data displayed on each pixel is formed using input image signals and the pixels are driven according to the input gradation data, the method comprising:
comparing two successive frames;
driving each of the two successive frames during a one-frame period when the two successive frames are not identical; and
driving only one frame of the two successive frames during a two-frame period when the two successive frames are identical.

2. The method of claim 1, wherein said comparing two successive frames comprises respectively comparing the input gradation data of the pixels in the two successive frames.

3. The method of claim 1, wherein in the driving operations of the panel, the panel is driven using a pulse width modulation method.

4. The method of claim 1, wherein in the driving operations of the panel, the panel is driven using a pulse amplitude modulation method.

5. The method of claim 1, wherein, in the driving operations of the panel, scan pulses are sequentially applied to the scan electrodes, and data pulses corresponding to the scan pulses are applied to the data electrodes.

6. The method of claim 5, wherein the scan pulses are progressively applied to the scan electrodes.

7. The method of claim 5, wherein the scan pulses are interlacingly applied to the scan electrodes.

8. An apparatus for driving an electron emission panel including pixels at regions where scan electrodes and data electrodes cross each other, comprising:
an image processor to generate image data;
a frame comparing unit to compare two successive frames of the image data;
a logic controller to generate a scan signal and a data signal based on the comparison result of the frame comparing unit;
a scan driving unit to drive the scan electrodes according to the scan signal; and
a data driving unit to drive the data electrodes according to the data signal,
wherein the logic controller generates the scan signal and the data signal to drive each of the two successive frames during a one-frame period when the two successive frames are not identical, and the logic controller generates the scan signal and the data signal to drive only one frame of the two successive frames during a two-frame period when the two successive frames are identical.

9. The apparatus of claim 8, wherein the frame comparing unit compares the two successive frames of image data by respectively comparing input gradation data of the pixels in the two successive frames.

10. The apparatus of claim 8, wherein in the driving operations of the panel, the panel is driven using a pulse width modulation method.

11. The apparatus of claim 8, wherein in the driving operations of the panel, the panel is driven using a pulse amplitude modulation method.

12. The apparatus of claim 8, wherein, in the driving operations of the panel, scan pulses are sequentially applied to the scan electrodes, and data pulses corresponding to the scan pulses are applied to the data electrodes.

13. The apparatus of claim 12, wherein the scan pulses are progressively applied to the scan electrodes.

14. The apparatus of claim 12, wherein the scan pulses are interlacingly applied to the scan electrodes.
